(19) United States
(12) Patent Application Publication
(10) Pub. No.: US 2005/0172853 A1
(43) Pub. Date: Aug. 11, 2005

(54) Recording liquids containing polyurethanes with hyperbranched structures

(75) Inventors: Bernd Bruchmann, FREINSHEIM (DE); Christian Kruger, Saulheim (DE); Ulrike Hees, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAF, LUDWIGSHAFEN (DE)

(21) Appl. No.: 10/508,701

(22) PCT Filed: Apr. 15, 2003
(86) PCT No.: PCT/EP03/03899

(51) Int. Cl. C09D 11/00

(52) U.S. Cl. 106/31.13

(57) ABSTRACT

The invention relates to novel polymeric dispersion additives with hyperbranched structures and to the use of polyurethanes with hyperbranched structures, selected from hyperbranched polyurethanes and modified hyperbranched polyurethanes.

The present invention relates to recording fluids, especially inks, containing polyurethanes having hyperbranched structures selected from
hyperbranched polyurethanes
and modified hyperbranched polyurethanes.

Specifically, the present invention relates to recording fluids wherein the modified hyperbranched polyurethane is obtainable by reaction of one or more hyperbranched polyurethanes with one or more polymers of the general formula I
U-(M)_{y}-T I
where
U is selected from hydrogen, C₁-C₁₈-alkyl, C₇-C₁₃-aralkyl, C₆-C₁₄-aryl and a residue from a free-radical initiator molecule,
each M represents the same or different monomer units;
y is an integer from 10 to 100 000;
T represents functional groups which react with the NCO groups or OH groups of hyperbranched polyurethanes to form modified hyperbranched polyurethanes.

Dispersing additives are of great technical and economic importance in numerous applications in which pigments are to be durably affixed to surfaces. These pigments must on the one hand satisfy the customarily stringent technical requirements and on the other be preparable at reasonable prices.

These requirements are particularly critical in recording fluids, most especially in inks for the ink jet process. Inks have to meet high requirements with regard to the stability of the dispersion, ie the pigments must not precipitate or flocculate out. Moreover, prints and script should have a brilliant color and possess high fastnesses such as for example rubfastness and/or wetrubfastness.

Whereas pigments themselves are no longer being deeply researched and use is made of the commonly known organic or inorganic pigments, dispersing additives are of substantial interest at present.

U.S. Pat. No. 6,096,801 discloses pigment formulations containing from 0.1 to 10 percent by weight of pigment and a resin, for example rosin, with dendrimers based on acetoacetmetaxilides, such as the BOLTORN® grades, or β-aminopropionamides. The disclosed dendrimers may be reacted at the ends of the arms with molecules which carry two or more hydroxyl groups, an example being pentaerythritol. They are very useful as dispersing additives but are costly and inconvenient to synthesize, and the formulations prepared using dendrimers are therefore disadvantageous from an economic viewpoint.

U.S. Pat. No. 5,561,214 discloses hyperbranched polyaspartate esters prepared by self-condensation of hydroxyaspartate esters. The hyperbranched polyaspartates may either be used as they are, and are suitable for use as binders, or they are reacted with polyisocyanates to give polyureas which are suitable for use as binders for a variety of coating systems. For commercial use as a dispersing additive, however, they are too costly to manufacture.

WO 00/37542 discloses the use of dendrimers as dispersants for hydrophobic particles in aqueous systems. Dendrimers for the purposes of WO 00/37542 also include so-called regular dendrones and hyperbranched polymers (page 7 line 1). As examples of hyperbranched polymers the reference cites the polyesters described in U.S. Pat. No. 5,418,301, which are obtainable for example by esterification of 2,2-dimethylolpropionic acid.

It is an object of the present invention to provide novel recording fluids containing dispersing additives which offer the technical advantages recited above and are easy to synthesize. It is a further object to provide a process for preparing the novel recording fluids, and it is yet another object to provide uses for recording fluids.

We have found that these objects are achieved, surprisingly, by the hyperbranched polyurethanes described at the beginning, which have at least one pigment affinity group, and modified hyperbranched polyurethanes in that they have been found to be very useful as dispersing additives in recording fluids. The preparation of hyperbranched polyurethanes having at least one group having affinity for pigment, which hereinafter will also be known as hyperbranched polyurethanes for short, and their modification are described hereinbelow.

For the purposes of the present invention, polyurethanes include not only polymers linked exclusively by urethane groups but also, in a more general sense, polymers obtainable by reacting diisocyanates or polyisocyanates with compounds containing active hydrogen atoms. Polyurethanes in the sense of the present invention may therefore contain not only urethane groups but also urea, allophanate, biuret, carbodiimide, amide, ester, ether, uretonimine, uretdione, isocyanurate or oxazolidine groups. An example of one overview that may be mentioned is that constituted by Kunststoffhandbuch [Plastics Handbook]/Saechtling, 26th Edition, Carl-Hanser-Verlag, Munich 1995, page 491 ff. In particular, polyurethanes in the sense of the present invention contain urea groups.

The present invention starts from hyperbranched polyurethanes which are molecularly and structurally nonuniform. They differ from dendrimers in their molecular nonuniformity and are much less costly and inconvenient to prepare.

The synthesis of the hyperbranched polyurethanes used to implement the present invention may be conducted, for example, as depicted below.

For the synthesis of the hyperbranched polyurethanes it is preferred to use ABₓ monomers containing both isocyanate groups and groups which may react with isocyanate groups to form a link. x is preferably a natural number from 2 to 8. x is preferably 2 or 3. Either A comprises isocyanate groups and B groups reactive therewith, or vice versa.

The groups that are reactive with the isocyanate groups preferably comprise OH, NH₂, NH, SH or COOH groups.

The ABₓ monomers are preparable conventionally by means of a variety of techniques.

ABₓ monomers may be synthesized, for example, by the method disclosed in WO 97/02304, using protective group techniques. By way of example, this technique is explained for the preparation of an AB₂ monomer from tolylene 2,4-diisocyanate (TDI) and trimethylolpropane. First of all, one of the isocyanate groups of the TDI is blocked in a known manner, by reaction with an oxime, for example. The remaining free NCO group is reacted with trimethylolpropane, one of the three OH groups reacting with the isocyanate group. After the protective group has been eliminated, a molecule containing one isocyanate group and two OH groups is obtained.

The ABₓ molecules may be synthesized with particular advantage by the method disclosed in DE-A 199 04 444, where no protective groups are needed. In this method, diisocyanates or polyisocyanates are used and are reacted with compounds containing at least two isocyanate-reactive groups. At least one of the reactants contains groups whose reactivity differs from that of the other reactant. Preferably, both reactants contain groups whose reactivity differs from that of the other reactant. The reaction conditions are chosen so that only specific reactive groups can react with one another.

Preferred diisocyanates and/or polyisocyanates containing NCO groups of different reactivity are, in particular, readily and cheaply available isocyanates, examples being aromatic isocyanates such as tolylene 2,4-diisocyanate (2,4-TDI), diphenylmethane 2,4′-diisocyanate (2,4′-MDI), triisocyanato-toluene, or aliphatic isocyanates, such as isophorone diisocyanate (IPDI), 2-butyl-2-ethylpentamethylene diisocyanate, 2-isocyanatopropylcyclohexyl isocyanate, 2,4,4- or 2,2,4-tri-methylhexamethylene diisocyanate, methylenebis(cyclohexyl) 2,4′-diisocyanate, and 4-methylcyclohexane 1,3-diisocyanate (H-TDI).

Further examples of isocyanates containing groups of different reactivity are phenylene 1,3-diisocyanate, phenylene 1,4-diisocyanate, naphthylene 1,5-diisocyanate, biphenyl diisocyanate, toluidine diisocyanate, and tolylene 2,6-diisocyanate.

It is of course also possible to use mixtures of said isocyanates.

Preferred compounds used containing at least two isocyanate-reactive groups are compounds with a functionality of two, three or four whose functional groups differ in their reactivity toward NCO groups. Preferred compounds are those containing at least one primary and at least one secondary hydroxyl group, at least one hydroxyl group and at least one mercapto group, with particular preference containing at least one hydroxyl group and at least one amino group, in the molecule, especially amino alcohols, amino diols, and amino triols, since the reactivity of the amino group in the reaction with isocyanate is substantially higher than that of the hydroxyl group.

Examples of said compounds containing at least two isocyanate-reactive groups differing in their reactivity include propylene glycol, glycerol, mercaptoethanol, ethanolamine, N-methyl-ethanolamine, diethanolamine, ethanolpropanolamine, dipropanolamine, diisopropanolamine, 2-amino-1,3-propanediol, 2-amino-2-methyl-1,3-propanediol or tris(hydroxymethyl)amino-methane. Furthermore, mixtures of said compounds may also be used.

The preparation of an AB₂ molecule is explained by way of example for the case of a diisocyanate with an amino diol. Here, first one mole of a diisocyanate is reacted with one mole of an amino diol, such as 2-amino-1,3-propanediol, at low temperatures, preferably in the range between −10 to +30° C. Within this temperature range, suppression of the urethane formation reaction is virtually complete, and the NCO groups of the isocyanate react exclusively with the amino group of the amino diol. The AB₂ molecule formed contains one free NCO group and two free OH groups and may be used to synthesize a hyperbranched polyurethane.

By heating or addition of catalyst, this AB₂ molecule may undergo intermolecular reaction to give a hyperbranched polyurethane. Examples of catalysts used to prepared the hyperbranched polyurethanes include organotin compounds such as tin diacetate, tin dioctoate, dibutyltin dilaurate or strongly basic amines such as diazabicyclooctane, diazabicyclononane, diazabicycloundecane, triethylamine, pentamethyldiethylenetriamine, tetramethyldiamino-ethyl ether or, preferably, triethylenediamine or bis(N,N-di-methylaminoethyl) ether or else weakly basic amines such as imidazoles, for example. It is also possible to use mixed catalysts comprising at least one organotin compound and at least one strongly basic amine. The catalysts are used preferably in an amount of from 0.01 to 10% by weight, more preferably from 0.05 to 5% by weight, based on isocyanate. The synthesis of the hyperbranched polyurethane takes place advantageously without prior isolation of the AB₂ molecule in a further reaction step at elevated temperature, preferably in the range between 30 and 80° C. When using the above-described AB₂ molecule containing two OH with one NCO group, a hyperbranched polymer is formed which contains per molecule one free NCO group and also a number of OH groups that is dependent on the degree of polymerization. The reaction may be carried out to high conversions, with the result that very high molecular weight structures are obtained. It is preferably terminated by adding suitable monofunctional compounds or by adding one of the starting compounds for preparing the AB₂ molecule when the desired molecular weight has been reached. Depending on the starting compound used for termination, either fully NCO-terminated or fully OH-terminated molecules are produced.

Alternatively, for example, an AB₂ molecule may also be prepared from one mole of glycerol and 2 mol of TDI. At a low temperature, the primary alcohol groups and also the isocyanate group in position 4 react preferentially, and an adduct is formed that contains one OH group and two isocyanate groups and which, as described, may be reacted at relatively high temperatures to form a hyperbranched polyurethane. The initial product is a hyperbranched polyurethane which contains one free OH group and an average number of NCO groups that is dependent on the degree of polymerization.

The number of NCO groups per molecule is from 2 to 100, preferably from 3 to 20, and with particular preference up to 10.

The molecular weight M_{w} of the hyperbranched polyurethanes to be used for the present invention is from 500 up to a maximum of 50 000 g/mol, preferably a maximum of 15 000 g/mol, with particular preference a maximum of 10 000 g/mol, and with very particular preference 5 000 g/mol.

The preparation of the hyperbranched polyurethanes may in principle be carried out without solvents, but preferably in solution. Solvents which are suitable in principle are all compounds which are liquid at the reaction temperature and are inert toward the monomers and polymers.

Other products are obtainable by further synthesis variants. By way of example, mention may be made at this point of AB₃ molecules. AB₃ molecules may be obtained, for example, by reacting diisocyanates with compounds containing 4 isocyanate-reactive groups. One example that may be mentioned is the reaction of tolylene diisocyanate with tris(hydroxymethyl)aminomethane.

To terminate the polymerization it is possible to use polyfunctional compounds which are able to react with the respective A groups. In this way it is possible to link a plurality of small hyperbranched molecules to form one large hyperbranched molecule.

Hyperbranched polyurethanes having chain-extended branches may be obtained, for example, by conducting the polymerization reaction using not only ABₓ molecules but also, in a molar ratio of 1:1, a diisocyanate and a compound containing two isocyanate-reactive groups. These additional AA and BB compounds, respectively, may also possess further functional groups which, however, must not be reactive toward the A or B groups under the reaction conditions. In this way it is possible to introduce further functionalities into the hyperbranched polymer.

Further synthesis variants for hyperbranched polyurethanes can be found in DE-A 100 13 187 and DE-A 100 30 869.

There is particular advantage in using hyperbranched polyurethanes whose functional groups are hydrophobicized, hydrophilicized, or converted. This makes it possible to obtain polyurethanes especially adapted to the inventive application of the hyperbranched polyurethanes in recording fluids, by introducing pigment affinity groups (i.e., groups having affinity for pigment). For conversion of functionality, very particular suitability is possessed, owing to their reactivity, by hyperbranched polyurethanes which contain isocyanate groups. It is of course also possible to convert OH— or NH₂-terminated polyurethanes by means of appropriate reactants.

Examples of pigment affinity groups which are introduced by means of appropriate reactants are —COOH, —COOR′, —CONHR′, —CONH₂, —OH, —SH, —NH₂, —NHR′, —NR′₂, —SO₃H, —SO₃R′, —N(phthalimide), —NHCOOR′, —NHCONH₂, —NHCONHR′ or —CN. The radicals R′ of said groups are straight-chain or branched alkyl radicals, aralkyl radicals, or aryl radicals, which may also be further substituted, by C₁-C₄₀ alkyl radicals or by C₆-C₁₄ aryl radicals, for example. The following radicals are particularly preferred:

C₁-C₄₀ alkyl, examples being methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl, and n-eicosyl; methyl is particularly preferred;

C₆-C₁₄ aryl, examples being phenyl, α-naphthyl, β-naphthyl, 1-anthracenyl, 2-anthracenyl, and 9-anthracenyl, C₇-C₁₃ aralkyl, preferably C₇ to C₁₂ phenylalkyl such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl, and 4-phenylbutyl, with particular preference benzyl.

Groups which possess sufficiently acidic hydrogen atoms may be converted into the corresponding salts by treatment with bases. Useful bases include for example the hydroxides and bicarbonates of alkali metals or alkaline earth metals or the carbonates of alkali metals. Useful bases further include volatile amines, ie amines having an atmospheric boiling point of up to 180° C., for example ammonia, methylamine, dimethylamine, trimethylamine, ethylamine, ethanolamine or methyldiethanolamine. Similarly, basic groups may be converted into the corresponding salts using acids such as α-hydroxy carboxylic acids or α-amino acids or else α-hydroxy sulfonic acids. By this means it is possible to obtain water-soluble hyperbranched polyurethanes.

Hydrophobicized products may be obtained by reacting NCO-terminated products with aliphatic or aromatic alcohols, thiols, primary or secondary amines or carboxylic acids. Particularly suitable are alcohols and primary and secondary amines having

C₄-C₄₀ alkyl radicals, for example n-butyl, n-hexyl; preferably C₈-C₄₀, for example n-octyl, n-decyl; having C₆-C₁₄ aryl radicals, the radicals being as defined above, or having heteroaromatic groups such as α-pyridyl, β-pyridyl, γ-pyridyl, N-pyrryl, α-pyrryl, β-pyrryl, porphyrinyl, 2-furanyl, 3-furanyl, 2-thiophenyl, 3-thiophenyl, N-pyrazolyl, N-imidazolyl, N-triazolyl, N-oxazolyl, N-indolyl, N-carbazolyl, 2-benzofuranyl, 2-benzothiophenyl, N-indazolyl, benzotriazolyl, 2-quinolinyl, 3-isoquinolinyl or α-phenanthrolinyl, for example.

Very particular preference is given to aromatic amines such as aniline or α-naphthylamine, for example; examples of particularly suitable carboxylic acid derivatives are carboxylic acids and carboxamides of aliphatic C₂-C₁₆ monocarboxylic or dicarboxylic acids and aromatic C₆-C₁₄ monocarboxylic or dicarboxylic acids. The reaction with phthalimide is of very particular preference.

Acid groups may be introduced, for example, by reaction with hydroxy carboxylic acids, mercapto carboxylic acids, hydroxy sulfonic acids or amino acids. Examples that may be mentioned of suitable reactants are hydroxyacetic acid, hydroxypivalic acid, 4-hydroxybenzoic acid, 12-hydroxydodecanoic acid, 2-hydroxy-ethanesulfonic acid, mercaptoacetic acid, dimethylolpropionic acid, glycine, β-alanine and taurine.

The above-described hyperbranched polyurethanes may be used as dispersing additives in recording fluids in accordance with the invention if they contain at least one hydrophilic group selected from —COOH, —CONHR′, —CONH₂—OH, —SH, —NH₂, —NHR′, —NR′₂, —SO₃H, —SO₃R′, —NHCOOR′ and —NHCONH₂.

Preference is given to recording fluids containing modified and especially hydrophilic-modified hyperbranched polyurethanes.

Preference is given to recording fluids containing such modified hyperbranched polyurethanes as are obtainable by reacting one or more hyperbranched polyurethanes with one or more polymers of the formula I
U-(M)_{y}-T I
where
U is hydrogen,
   C₁-C₁₈ alkyl, branched or unbranched, e.g., methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, and n-octadecyl; preferably C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, with particular preference C₁-C₄ alkyl such as methyl, ethyl, n-propyl, isopropyl, n-butyl, isobutyl, sec-butyl, and tert-butyl;
   C₆-C₁₄ aryl, e.g., phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, with particular preference phenyl;
   C₇-C₁₃ aralkyl, preferably C₇- to C₁₂ phenylalkyl such as benzyl, 1-phenethyl, 2-phenethyl, 1-phenylpropyl, 2-phenylpropyl, 3-phenylpropyl, neophyl (1-methyl-1-phenyl-ethyl), 1-phenylbutyl, 2-phenylbutyl, 3-phenylbutyl, and 4-phenylbutyl, with particular preference benzyl;
   or a residue of an initiator molecule, such as 2,2-dimethyl-2-cyanoethyl, or of another initiator molecule such as the common organic peroxides, organic azo compounds, or C—C-cleaving initiators such as dialkyl peroxides, peroxocarboxylic acids, peroxydicarbonates, peroxide esters, hydroperoxides, ketone peroxides, azo dinitriles or benzpinacol silyl ethers.
M stands for one or more different monomer units, examples being (meth)acrylate units, (meth)acrylamide units, polyvinyl acetate units, polyvinyl alcohol units or polyethyleneimine units, linear polyurethane units, polyester units, polystyrene units, polyether units such as polyethylene glycol or polytetrahydrofuran units, or polyethylene or polyamide units;
y is an integer from 10 to 100 000, preferably from 100 to 10 000.
T are functional groups which are able to react with the NCO groups or OH, NH or SH groups of the polymeric dispersing additives of the invention, examples being OH, NHR, SH, carboxyl or carboxylamide groups.

The abovementioned monomer units are for example:

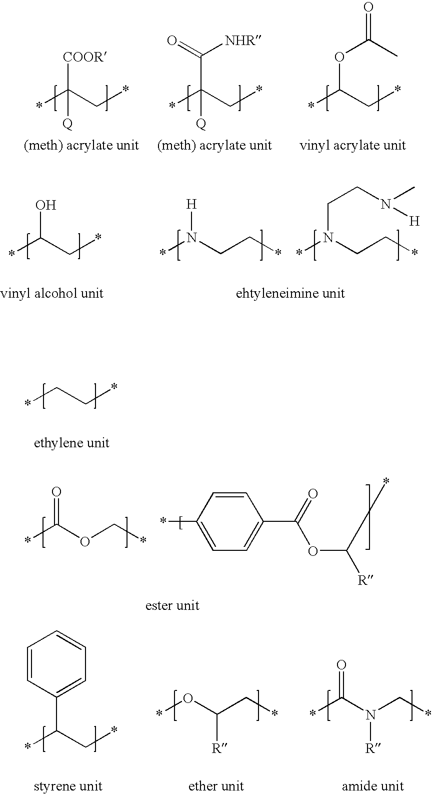

R″ is hydrogen or is R′. Q is hydrogen or methyl.

Where the above-described dispersing additives contain one or more free NCO groups, T is chosen from OH, NHR and SH. Where the above-described dispersing additives contain one or more free OH, NH or SH groups, T is preferably selected from carboxyl groups.

The reaction of the hyperbranched polyurethanes with the polymer or polymers of the formula I is customarily carried out at from −20 to 120° C. and preferably at up to +60° C. The reaction can be speeded by adding a catalyst. Useful catalysts for preparing the modified polyurethanes include the familiar catalysts from polyurethane chemistry, for example:
organic tin compounds such as for example tin diacetate, tin dioctoate, dibutyltin dilaurate,
strongly basic amines such as diazabicyclooctane, diazabicyclononane, diazabicycloundecane, triethylamine, pentamethyldiethylenetriamine, tetramethyldiaminoethyl ether, or preferably triethylenediamine or bis(N,N-dimethylaminoethyl) ether or else weakly basic amines such as for example imidazole.

It is also possible to use mixed catalysts comprising at least one organic tin compound and at least one strongly basic amine. The catalysts are preferably used in an amount from 0.01 to 10% by weight and preferably from 0.05 to 5% by weight. The reaction can be carried out in a solvent, in which case useful solvents include in principle all solvents which react neither with the polyurethane nor with the polymer.

Preference is given to recording fluids which contain modified hyperbranched polyurethanes, the modified hyperbranched polyurethane being obtainable by reaction of a deficiency, based on the NCO groups of the hyperbranched polyurethane, of polymer of the formula I with one or more hyperbranched polyurethanes, and subsequent conversion of the remaining NCO groups into pigment affinity groups, especially into carboxyl groups.

Particular preference is given to recording fluids containing such modified hyperbranched polyurethanes as are obtainable by reaction of the above-described hyperbranched polyurethanes with a polyether derivative or a mixture of at least two polyether derivatives.

For the purposes of the present invention, polyether derivatives include for example polyalkylene glycol derivatives of the general formula II 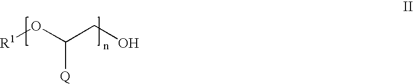
where
R¹ is selected from hydrogen or preferably
C₁-C₄₀-alkyl, examples being methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-hexadecyl, and n-eicosyl; methyl is particularly preferred; where the C₁-C₄₀-alkyl may be substituted by one or more hydroxyl groups with the proviso that the number of hydroxyl groups is not more than the number of carbon atoms in the C₁-C₄₀-alkyl in question;
C₆-C₁₄-aryl, examples being phenyl, α-naphthyl, β-naphthyl, 1-anthracenyl, 2-anthracenyl and 9-anthracenyl;
C₇-C₁₃-aralkyl, preferably C₇- to C₁₂-phenylalkyl such as benzyl, 1-phenethyl, 2-phenethyl, 1-phenylpropyl, 2-phenylpropyl, 3-phenylpropyl, neophyl (1-methyl-1-phenylethyl), 1-phenylbutyl, 2-phenylbutyl, 3-phenylbutyl and 4-phenylbutyl, with particular preference benzyl.
n is an integer from 2 to 500, preferably from 2 to 200, with particular preference from 5 to 100, and with very particular preference up to 50.

For the purposes of the present invention, polyether derivatives further include polytetrahydrofuran derivatives of the general formula III 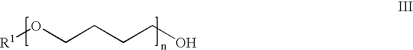
in which the variables are as defined above.

For the purposes of the present invention, polyether derivatives additionally include copolymers of ethylene oxide and propylene oxide or butylene oxide or terpolymers of ethylene oxide and propylene oxide and butylene oxide, it being possible for the copolymers to be present in the form of block copolymers or random copolymers and/or terpolymers. The molar ratios of the monomers are not critical. Examples of block copolymers are the Pluronics® grades from BASF Aktiengesellschaft. Finally, for the purposes of the present invention, polyether derivatives also embrace the Tetronics® grades from BASF Aktiengesellschaft, which are branched block copolymers of ethylene oxide and propylene oxide in which branching takes place by incorporation of one ethylenediamine unit per molecule.

For the purposes of the present invention, polyalkylene derivatives of the formula II also include mixtures of plural polyalkylene derivatives of the formula II.

Preferred polyalkylene glycol derivatives for the purposes of the present invention are methyl-capped polyethylene glycol derivatives of the general formula II.

The reaction of the hyperbranched polyurethanes with the polyalkylene glycol derivatives of the formula II or with the polytetrahydrofuran derivatives of the formula III customarily takes place at from −20 to +60° C. The reaction may be carried out by adding a catalyst. Useful catalysts used for preparing the preferred modified polyurethanes include the abovementioned straight and mixed catalysts from polyurethane chemistry.

The catalysts are preferably used in an amount from 0.01 to 10% by weight and preferably from 0.05 to 5% by weight. The reaction can be carried out in a solvent, in which case useful solvents include in principle all solvents which react neither with the polyurethane nor with the polyether derivative.

The molar ratio of the reactants influences the dispersing properties of the hyperbranched polyurethane. The molar ratios may be chosen so that one NCO group is used per equivalent of OH groups of the polyether derivative. However, it is also possible to use a deficiency of OH group equivalents and subsequently to react the unconverted NCO groups of the modified hyperbranched polyurethane with alkanols, arylamines or alkylamines, especially alkanols and alkylamines having C₈-C₄₀-alkyl radicals or arylamines having C₆-C₁₄-aryl radicals such as for example aniline or α-naphthylamine to form groups having affinity for pigment.

In a very particularly preferred embodiment, the recording fluids of the present invention contain one or more melamine derivatives of the general formula IV 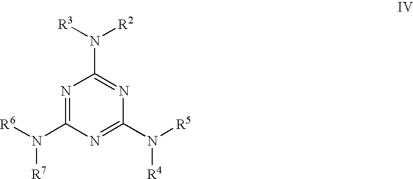
where R² to R⁷ are the same or different and are each selected from:
hydrogen or
CH₂—OR⁸, CH(OR⁸)₂ and CH₂—N(R⁸)₂,
where each R⁸ may be the same or different and is selected from hydrogen,
C₁-C₁₂-alkyl, branched or unbranched, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec-butyl and tert-butyl;
alkoxyalkylene such as (—CH₂—CH₂—O)ₘ—H, (—CHCH₃—CH₂—O)ₘ—H, (—CH₂—CHCH₃—O)ₘ—H, (—CH₂—CH₂—CH₂—CH₂—O)ₘ—H, where m is an integer from 1 to 20, preferably from 1 to 10 and more preferably from 1 to 5.

R², R⁴ and R⁶ are preferably different.

Particularly preferably R² and R³ are both hydrogen and R⁴ and R⁵ are both CH₂—OH. Most preferably, R² and R³ are both hydrogen and R⁴ is CH₂—OH.

Melamine derivatives of the general formula IV are known per se and are commercially obtainable for example as Luwipal® from BASF Aktiengesellschaft and as Cymel® 327 from Cytec. Melamine derivatives for the purposes of the present invention are generally not pure in accordance with any defined formula; it is usual to observe intermolecular rearrangements of R² to R⁷, i.e., transacetalization reactions and transaminalization reactions, and also to some extent condensation reactions and elimination reactions. The formula IV indicated above is to be understood as defining the stoichiometric ratios of the substituents and as also encompassing intermolecular rearrangement products and condensation products.

The above-described hyperbranched polyurethanes and melamine derivatives of the general formula IV are customarily used in a eight ratio in the range from 0.01:1 to 100:1, preferably 0.1:1 to 50:1 and more preferably from 1:1 to 10:1.

The present invention further provides dispersing binder systems obtainable by mixing hyperbranched polyurethanes or modified hyperbranched polyurethanes with one or more melamine derivatives of the general formula IV 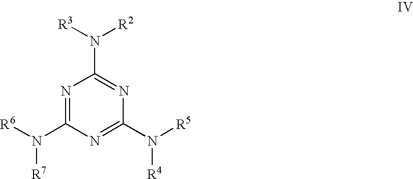
where R² to R⁷ are the same or different and are each selected from:
hydrogen or
CH₂—OR⁸, CH(OR⁸)₂ and CH₂—N(R⁸)₂,
where each R⁸ may be the same or different and is selected from hydrogen,
C₁-C₁₂-alkyl, branched or unbranched, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl and n-dodecyl; preferably C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec-butyl and tert-butyl;
alkoxyalkylene such as (—CH₂—CH₂—O)ₘ—H, (—CHCH₃—CH₂—O)ₘ—H, (—CH₂—CHCH₃—O)ₘ—H, (—CH₂—CH₂—CH₂—CH₂—O)ₘ—H, where m is an integer from 1 to 20, preferably from 1 to 10 and more preferably from 1 to 5, in a weight ratio in the range from 0.01:1 to 100:1, preferably 0.1:1 to 50:1 and more preferably 1:1 to 10:1.

R², R⁴ and R⁶ are preferably different.

Particularly preferably R² and R³ are both hydrogen and R⁴ and R⁵ are both CH₂—OH. Most preferably, R² and R³ are both hydrogen and R⁴ is CH₂—OH.

A further aspect of the present invention is a process for preparing the dispersing binders of the present invention. The process of the present invention involves mixing one or more of the above-described hyperbranched polyurethanes or one or more of the above-described modified hyperbranched polyurethanes with one or more melamine derivatives of the formula IV, for example in ball mills, stirred media mills, dispensers, dissolvers or basket mills. Example of such assemblies are commercially available from Getzmann or Skandex.

A further aspect of the present invention is a process for preparing the recording fluids of the present invention using the above-described hyperbranched polyurethanes or the above-described modified hyperbranched polyurethanes. The process of the present invention comprises intimately mixing one or more above-described hyperbranched polyurethanes or one or more above-described modified hyperbranched polyurethanes with water, one or more finely divided inorganic or organic colorants, optionally one or more melamine derivatives of the general formula IV and optionally assistants.

A further aspect of the present invention is a process for preparing colorant preparations using the dispersing binders of the present invention and also a process for preparing recording fluids using the dispersing binders of the present invention and/or the colorant preparations of the present invention.

The colorant preparations of the present invention are obtained by mixing the dispersing binders of the present invention with one or more finely divided inorganic or organic colorants, for example in a ball mill. The colorant preparations of the present invention are preferably prepared by not isolating the dispersing binders of the present invention and mixing the above-described hyperbranched polyurethanes or the above-describedly modified hyperbranched polyurethanes with one or more melamine derivatives of the general formula IV, water and one or more sparingly water-soluble colorants in a ball mill for example. The dispersing binders of the present invention will form in situ in the course of the preparation of the colorant preparations of the present invention. Ball-milled colorant preparations according to the present invention are also known as grinds.

The colorant preparations according to the invention, as well as the dispersing binders, include water and also finely divided organic or inorganic colorants, i.e., pigments as defined in German standard specification DIN 55944, that are preferably substantially insoluble in water and/or in a water-solvent mixture. Instead of pigments it is also possible to use vat dyes and disperse dyes. It will be appreciated that the colorant preparations of the invention may also include colorant mixtures, but preferably only one colorant is present. By way of brightening agents, these pigment preparations may include dyes, especially direct, acid or reactive dyes, that are similar in hue to the pigment.

There now follow preferred examples of useful colorants for the invention:

Organic pigments:

monoazo pigments: C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments: C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments: C.I. Pigment Red 168 (C.I. Vat Orange 3);
anthraquinone pigments: C.I. Pigment Yellow 147 and 177; C.I. Pigment Violet 31;
anthraquinone pigments: C.I. Pigment Yellow 147 and 177; C.I. Pigment Violet 31;
anthrapyrimidine pigments: C.I. Pigment Yellow 108 (C.I. Vat Yellow 20);
quinacridone pigments: C.I. Pigment Red 122, 202 and 206; C.I. Pigment Violet 19;
quinophthalone pigments: C.I. Pigment Yellow 138;
dioxazine pigments: C.I. Pigment Violet 23 and 37;
flavanthrone pigments: C.I. Pigment Yellow 24 (C.I. Vat Yellow 1);
indanthrone pigments: C.I. Pigment Blue 60 (C.I. Vat Blue 4) and 64 (C.I. Vat Blue 6);
isoindoline pigments: C.I. Pigment Orange 69; C.I. Pigment Red 260; C.I. Pigment Yellow 139 and 185;
isoindolinone pigments: C.I. Pigment Orange 61; C.I. Pigment Red 257 and 260; C.I. Pigment Yellow 109, 110, 173 and 185;
isoviolanthrone pigments: C.I. Pigment Violet 31 (C.I. Vat Violet 1);
metal complex pigments: C.I. Pigment Yellow 117, 150 and 153; C.I. Pigment Green 8;
perinone pigments: C.I. Pigment Orange 43 (C.I. Vat Orange 7); C.I. Pigment Red 194 (C.I. Vat Red 15);
perylene pigments: C.I. Pigment Black 31 and 32; C.I. Pigment Red 123, 149, 178, 179 (C.I. Vat Red 23), 190 (C.I. Vat Red 29) and 224; C.I. Pigment Violet 29;
phthalocyanine pigments: C.I. Pigment Blue 15, 15:1, 15:2, 15:3, 15:4, 15:6 and 16; C.I. Pigment Green 7 and 36;
pyranthrone pigments: C.I. Pigment Orange 51; C.I. Pigment Red 216 (C.I. Vat Orange 4);
thioindigo pigments: C.I. Pigment Red 88 and 181 (C.I. Vat Red 1); C.I. Pigment Violet 38 (C.I. Vat Violet 3);
triarylcarbonium pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);
C.I. Pigment Brown 22;
   vat dyes (in addition to those already mentioned above):
C.I. Vat Yellow 2, 3, 4, 5, 9, 10, 12, 22, 26, 33, 37, 46, 48, 49 and 50;
C.I. Vat Orange 1, 2, 5, 9, 11, 13, 15, 19, 26, 29, 30 and 31;
C.I. Vat Red 2, 10, 12, 13, 14, 16, 19, 21, 31, 32, 37, 41, 51, 52 and 61;
C.I. Vat Violet 2, 9, 13, 14, 15, 17 and 21;
C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74;
C.I. Vat Green 1, 2, 3, 5, 7, 8, 9, 13, 14, 17, 26, 29, 30, 31, 32, 33, 40, 42, 43, 44 and 49;
C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84;
C.I. Vat Black 1, 2, 7, 8, 9, 13, 14, 16, 19, 20, 22, 25, 27, 28, 29, 30, 31, 32, 34, 36, 56, 57, 58, 63, 64 and 65;
   inorganic pigments:
white pigments: titanium dioxide (C.I. Pigment White 6), zinc white, pigment grade zinc oxide; zinc sulfide, lithopone; lead white;
black pigments: iron oxide black (C.I. Pigment Black 11), iron manganese black, spinel black (C.I. Pigment Black 27); carbon black (C.I. Pigment Black 7);
color pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36); ultramarine blue; iron blue (C.I. Pigment Blue 27); manganese blue; ultramarine violet; cobalt violet and manganese violet; iron oxide red (C.I. Pigment Red 101); cadmium sulfoselenide (C.I. Pigment Red 108); molybdate red (C.I. Pigment Red 104); ultramarine red;
   iron oxide brown, mixed brown, spinel and corundum phases (C.I. Pigment Brown 24, 29 and 31), chrome orange;
   iron oxide yellow (C.I. Pigment Yellow 42); nickel titanium yellow (C.I. Pigment Yellow 53; C.I. Pigment Yellow 157 and 164); chrome titanium yellow; cadmium sulfide and cadmium zinc sulfide (C.I. Pigment Yellow 37 and 35); chrome yellow (C.I. Pigment Yellow 34), zinc yellow, alkaline earth metal chromates; Naples yellow; bismuth vanadate (C.I. Pigment Yellow 184);
interference pigments: metallic effect pigments based on coated metal platelets; pearl luster pigments based on mica platelets coated with metal oxide; liquid crystal pigments.

Preferred pigments in this context are monoazo pigments (especially laked BONS pigments, Naphtol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Examples of particularly preferred pigments are specifically: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

The following pigment combinations are particularly recommended:
C.I. Pigment Yellow 138, C.I. Pigment Violet 19, C.I. Pigment Blue 15:3 and C.I. Pigment Black 7;
C.I. Pigment Yellow 138, C.I. Pigment Red 122, C.I. Pigment Blue 15:3 or 15:4 and C.I. Pigment Black 7;
C.I. Pigment Yellow 138, C.I. Pigment Violet 19, C.I. Pigment Blue 15:3, C.I. Pigment Black 7, C.I. Pigment Orange 43 and C.I. Pigment Green 7;
C.I. Pigment Yellow 138, C.I. Pigment Red 122, C.I. Pigment Blue 15:3 or 15:4, C.I. Pigment Black 7, C.I. Pigment Orange 5 and C.I. Pigment Green 7;
C.I. Pigment Yellow 138, C.I. Pigment Red 122, C.I. Pigment Blue 15:3 or 15:4, C.I. Pigment Black 7, C.I. Pigment Orange 38 and C.I. Pigment Green 7;
C.I. Pigment Yellow 138, C.I. Pigment Red 122, C.I. Pigment Blue 15:3 or 15:4, C.I. Pigment Black 7, C.I. Pigment orange 43 and C.I. Pigment Green 7.

Useful substantially water-insoluble dyes, as well as the vat dyes already mentioned, include in particular azo, anthraquinone, quinophthalone, benzodifuran, methine and azamethine dyes which are free of acidic or ionic groups.
C.I. Disperse Yellow 1, 2, 3, 4, 5, 6, 7, 8, 9, 10, 11, 11:1, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 179, 180, 181, 182, 183, 184, 184:1, 198, 200, 201, 202, 203, 204, 205, 206, 207, 208, 209, 210, 211, 212, 213, 214, 215, 216, 217, 218, 219, 220, 221, 222, 223, 224, 225, 226, 227 and 228;
C.I. Disperse Orange 1, 2, 3, 3:3, 4, 5, 6, 7, 8, 9, 10, 11, 12, 13, 14, 15, 16, 17, 18, 19, 20, 21, 22, 23, 24, 25, 25:1, 26, 27, 28, 29, 30, 31, 32, 33, 34, 35, 36, 37, 38, 39, 40, 41, 41:1, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 126, 127, 128, 129, 130, 131, 136, 137, 138, 139, 140, 141, 142, 143, 145, 146, 147 and 148;
C.I. Disperse Red 1, 2, 3, 4, 5, 5:1, 6, 7, 8, 9, 10, 11, 12, 13, 14, 15, 16, 17, 18, 19, 20, 21, 22, 23, 24, 25, 26, 27, 28, 29, 30, 30:1, 31, 32, 33, 34, 35, 36, 38, 39, 40, 41, 43, 43:1, 46, 48, 50, 51, 52, 53, 54, 55, 55:1, 56, 58, 59, 60, 61, 63, 65, 66, 69, 70, 72, 73, 74, 75, 76, 77, 79, 80, 81, 82, 84, 85, 86, 86:1, 87, 88, 89, 90, 91, 92, 93, 94, 96, 97, 98, 100, 102, 103, 104, 105, 106, 107, 108, 109, 110, 111, 112, 113, 115, 116, 117, 118, 120, 121, 122, 123, 125, 126, 127, 128, 129, 130, 131, 132, 133, 134, 135, 136, 137, 138, 139, 140, 141, 142, 143, 144, 145, 146, 147, 148, 149, 150, 151, 151:1, 152, 153, 154, 155, 156, 157, 158, 159, 160, 161, 162, 163, 164, 165, 166, 167, 167:1, 168, 169, 170, 171, 172, 173, 174, 175, 176, 177, 178, 179, 180, 181, 182, 183, 184, 185, 186, 187, 188, 189, 190, 190:1, 191, 191:1, 192, 193, 194, 195, 211, 223, 224, 273, 274, 275, 276, 277, 278, 279, 280, 281, 302:1, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 338, 339, 340, 341, 342, 343, 344, 346, 347, 348, 349, 352, 356 and 367;
C.I. Disperse Violet 1, 2, 3, 4, 4:1, 5, 6, 7, 8, 9, 10, 11, 12, 13, 14, 15, 16, 17, 18, 19, 20, 21, 22, 23, 24, 25, 26, 27, 28, 29, 31, 33, 34, 35, 36, 37, 38, 39, 40, 41, 42, 43, 44, 45, 46, 47, 48, 49, 50, 51, 52, 53, 54, 55, 56, 57, 58, 59, 60, 70, 81, 86, 87, 88, 89, 91, 92, 93, 94, 96 and 97;
C.I. Disperse Blue 1, 1:1, 2, 3, 3:1, 4, 5, 6, 7, 7:1, 8, 9, 10, 11, 12, 13, 13:1, 14, 15, 16, 17, 18, 19, 20, 21, 22, 23, 23:1, 24, 25, 26, 27, 28, 29, 30, 31, 32, 33, 34, 35, 36, 38, 39, 40, 42, 43, 44, 45, 47, 48, 49, 51, 52, 53, 54, 55, 56, 58, 60, 60:1, 61, 62, 63, 64, 64:1, 65, 66, 68, 70, 72, 73, 75, 76, 77, 79, 80, 81, 81:1, 82, 83, 84, 85, 86, 87, 88, 89, 90, 91, 92, 93, 94, 95, 96, 97, 98, 99, 100, 101, 102, 103, 104, 105, 106, 107, 108, 109, 111, 112, 113, 114, 115, 116, 117, 118, 119, 121, 122, 123, 124, 125, 126, 127, 128, 130, 131, 132, 133, 134, 136, 137, 138, 139, 140, 141, 142, 143, 144, 145, 146, 147, 148, 149, 150, 151, 152, 153, 154, 155, 156, 158, 159, 160, 161, 162, 163, 164, 165, 165:2, 166, 167, 168, 169, 170, 171, 172, 173, 174, 175, 195, 281, 282, 283, 283:1, 284, 285, 286, 287, 288, 289, 290, 291, 292, 293, 294, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 349, 351 and 359;
C.I. Disperse Green 1, 2, 5, 6 and 9;
C.I. Disperse Brown 1, 2, 3, 4, 4:1, 5, 7, 8, 9, 10, 11, 18, 19, 20 and 21;
C.I. Disperse Black 1, 3, 4, 5, 6, 7, 8, 9, 10, 11, 12, 13, 14, 15, 20, 22, 24, 25, 26, 27, 28, 29, 29:1, 30, 31, 32, 33, 34 and 36;
C.I. Solvent Yellow 2, 3, 7, 12, 13, 14, 16, 18, 19, 21, 25, 25:1, 27, 28, 29, 30, 33, 34, 36, 42, 43, 44, 47, 56, 62, 72, 73, 77, 79, 81, 82, 83, 83:1, 88, 89, 90, 93, 94, 96, 98, 104, 107, 114, 116, 117, 124, 130, 131, 133, 135, 141, 143, 144, 145, 146, 157, 160:1, 161, 162, 163, 167, 169, 172, 173, 176, 179, 180, 181, 182, 183, 184, 185, 186, 187, 189, 190 and 191;
C.I. Solvent Orange 1, 2, 3, 4, 5, 7, 11, 14, 20, 23, 25, 31A, 40:1, 41, 45, 54, 56, 58, 60, 62, 63, 70, 75, 77, 80, 81, 86, 99, 102, 103, 105, 106, 107, 108, 109, 110, 111, 112 and 113;
C.I. Solvent Red 1, 2, 3, 4, 8, 16, 17, 18, 19, 23, 24, 25, 26, 27, 30, 33, 35, 41, 42, 45, 48, 49, 52, 68, 69, 72, 73, 83:1, 84:1, 89, 90, 90:1, 91, 92, 106, 109, 111, 118, 119, 122, 124, 125, 127, 130, 132, 135, 141, 143, 145, 146, 149, 150, 151, 155, 160, 161, 164, 164:1, 165, 166, 168, 169, 172, 175, 179, 180, 181, 182, 195, 196, 197, 198, 207, 208, 210, 212, 214, 215, 218, 222, 223, 225, 227, 229, 230, 233, 234, 235, 236, 238, 239, 240, 241, 242, 243, 244, 245, 247 and 248;
C.I. Solvent Violet 2, 8, 9, 11, 13, 14, 21, 21:1, 26, 31, 36, 37, 38, 45, 46, 47, 48, 49, 50, 51, 55, 56, 57, 58, 59, 60 and 61;
C.I. Solvent Blue 2, 3, 4, 5, 7, 18, 25, 26, 35, 36, 37, 38, 43, 44, 45, 48, 51, 58, 59, 59:1, 63, 64, 67, 68, 69, 70, 78, 79, 83, 94, 97, 98, 99, 100, 101, 102, 104, 105, 111, 112, 122, 124, 128, 129, 132, 136, 137, 138, 139 and 143;
C.I. Solvent Green 1, 3, 4, 5, 7, 28, 29, 32, 33, 34 and 35;
C.I. Solvent Brown 1, 3, 4, 5, 12, 20, 22, 28, 38, 41, 42, 43, 44, 52, 53, 59, 60, 61, 62 and 63;
C.I. Solvent Black 3, 5, 5:2, 7, 13, 22, 22:1, 26, 27, 28, 29, 34, 35, 43, 45, 46, 48, 49 and 50.

Also useful are substituted benzodifuranone dyes, the basic structure of which conforms to the formula A.

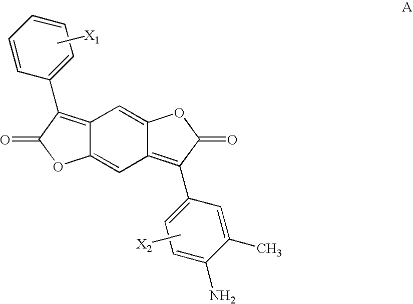

Such dyes may be substituted on either or both of the phenyl rings. Useful substituents X¹ and X² include halogen, alkyl with or without interruption by nonadjacent oxygen atoms, alkoxy with or without interruption by oxygen atoms and substitution in the alkyl moiety, hydroxyl, substituted or unsubstituted amino, cyano, nitro and alkoxycarbonyl.

Useful dyes further include dyes of the following formulae B to E:

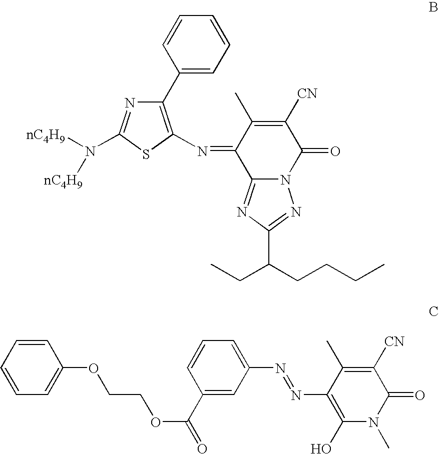

These and further examples of colorants are found in W. Herbst, K. Hunger, Industrial Organic Pigments, VCH Weinheim, 1993.

The colorant preparations according to the invention generally include from 0.01 to 20% by weight, preferably from 0.2 to 10% by weight and more preferably from 1 to 6% by weight of colorant, amounts in the range from 1 to 6% by weight being particularly suitable.

The dispersed colorants should be very finely divided. Preferably 95% and more preferably 99% of the colorant particles have an average particle diameter of 1 μm, preferably 0.5 μm and more preferably up to 0.2 μm. The average particle diameter is preferably at least 0.05 μm.

Water is the main constituent of the colorant preparations according to the invention, preference being given to demineralized water as obtainable for example through the use of an ion exchanger. The water content is customarily in the range from 30 to 95% by weight. The water content of preparations according to the invention is preferably in the range from 40 to 60% by weight.

The colorant preparations according to the invention generally contain from 1 to 40% by weight and preferably from 5 to 30% by weight of dispersing binder.

The colorant preparations of the present invention may contain further assistants.

For example, the colorant preparations according to the invention may include one or more organic solvents. Low molecular weight polytetrahydrofuran is a preferred assistant, and it can be used alone or preferably mixed with one or more high-boiling water-soluble or -miscible organic solvents.

The preferred polytetrahydrofuran customarily has an average molecular weight M_{w} of from 150 to 500 g/mol, preferably from 200 to 300 g/mol and more preferably of about 250 g/mol.

Polytetrahydrofuran is preparable in known manner by cationic polymerization of tetrahydrofuran. The products are linear polytetramethylene glycols.

Other organic solvents used as assistants are generally high-boiling and hence water-retaining organic solvents that are soluble in or miscible with water. High-boiling solvents have a boiling point >100° C.

Useful solvents include polyhydric alcohols, preferably branched and unbranched polyhydric alcohols containing from 2 to 8 and especially from 3 to 6 carbon atoms, such as ethylene glycol, 1,2-propylene glycol, 1,3-propylene glycol or glycerol.

Useful solvents further include polyethylene glycols and polypropylene glycols (which is also to be understood as meaning the lower polymers (di-, tri- and tetramers)) and their monoalkyl (especially C₁-C₆ and in particular C₁-C₄ alkyl) ethers. Preference is given to polyethylene and polypropylene glycols having average molecular weights of from 100 to 1 500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ether.

Useful solvents further include pyrrolidone and N-alkyl-pyrrolidones whose alkyl chain preferably contains from 1 to 4, especially 1 or 2, carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} from 300 to 500 g/mol), diethylene glycol monobutyl ether, triethylene glycol mono-n-butyl ether, pyrrolidone, N-methylpyrrolidone and N-(2-hydroxyethyl)-pyrrolidone.

The polytetrahydrofuran may also be mixed with one or more (e.g., two, three or four) of the abovementioned solvents.

The colorant preparations according to the invention generally include from 0.1 to 40% by weight, preferably from 2.5 to 30% by weight, more preferably from 5 to 25% by weight and most preferably from 10 to 20% by weight of solvent.

The solvent, including especially the particularly preferred solvent combinations mentioned, may advantageously be augmented by urea (generally from 0.5 to 3% by weight, based on the weight of the colorant preparation), which further enhances the water-retaining effect of the solvent.

The recording fluids of the present invention may include further assistants of the type which are customary especially for aqueous ink jet inks and in the printing and coatings industry. Examples of such assistants include preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degassers/defoamers (such as acetylenediols and ethoxylated acetylenediols, which customarily contain from 20 to 40 mol of ethylene oxide per mole of acetylenediol and may also have a dispersing effect), viscosity regulators, flow agents, wetters (e.g., wetting surfactants based on ethoxylated or propoxylated fatty or oxo alcohols, propylene oxide/ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyether siloxane copolymers, especially alkoxylated 2-(3-hydroxypropyl)heptamethyl-trisiloxanes, which generally have a block of from 7 to 20 and preferably of from 7 to 12 ethylene oxide units and a block of from 2 to 20 and preferably of from 2 to 10 propylene oxide units and may be present in the colorant preparations in amounts of from 0.05 to 1% by weight), anti-settlers, luster improvers, lubricants, adhesion improvers, anti-skinning agents, delusterants, emulsifiers, stabilizers, water repellents, light control additives, hand improvers, antistats and bases such as triethanolamine or acids, especially carboxylic acids such as lactic acid or citric acid, for regulating the pH. If such assistants are part of the pigment preparations of the invention, their total amount is generally 2% by weight, especially 1% by weight, based on the weight of the colorant preparation.

The recording fluids according to the invention customarily have a dynamic viscosity of from 1 to 20 mPa·s and preferably from 2 to 15 mPa·s, as measured using a rotary viscometer from Haake in accordance with German standard specification DIN 53019-1.

The surface tension of the recording fluids according to the invention is generally in the range from 24 to 70 mN/m and especially in the range from 30 to 60 mN/m, as measured using a K 10 digital tensiometer from Krüss at room temperature. The pH of the colorant preparations according to the invention is generally in the range from 5 to 10 and preferably in the range from 7 to 9, as measured using a 763 pH meter from Knick.

The recording fluids of the present invention have a particularly low kinematic viscosity, especially when compared with recording fluids which contain a conventional polymeric binder.

The recording fluids according to the present invention may be formulated by mixing one or more hyperbranched polyurethanes with water, one or more inorganic or organic colorants and one or more melamine derivatives of the general formula IV and also optionally additives to form grinds as described above. However, it is also possible for the melamine derivative or derivatives not to be added until the dilution with water and thus to the final formulation of the ink.

The present invention further provides for the use of the colorant preparations of the present invention for preparing recording fluids, especially for preparing inks for ink jet printing, and also a process for preparing recording fluids from the colorant preparations of the present invention. Further aspects of the present invention are a process for preparing recording fluids of the present invention using colorant preparations of the present invention and also the recording fluids thus prepared.

The recording fluids of the present invention are prepared from the colorant preparations of the present invention by diluting the colorant preparations of the present invention with water. As well as water, further solvents and assistants may be added, the solvents and assistants being as defined above.

The colorant preparations of the present invention and recording fluids of the present invention which are prepared from colorant preparations of the present invention are very particularly advantageous for preparing ink jet ink sets. The level of particular colorants in the individual recording fluids must be adapted to the particular requirements (eg trichromism) and is readily determined in a few printing trials and simple optimizations.

A further aspect of the present invention is a process for printing sheetlike or three-dimensional substrates by the ink jet process using the recording fluids of the present invention. To this end, one or more recording fluids of the present invention, especially inks, are printed onto the substrate.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble jet process) to exert pressure on the ink system and so eject an ink droplet. These techniques are described in Text. Chem. Color 19 (1987), No. 8, 23-29, and 21 (1989), No. 6, 27-32.

The recording fluids of the invention are particularly useful for the continuous ink jet process or the process employing a piezoelectric crystal.

The areas printed by the ink jet process are customarily treated with heat in order that the prints may be fixed and the dispersing binder system may be crosslinked. The heating may be effected using steam or hot air for example. A customary temperature range is from 150 to 180° C. for from 5 to 8 minutes. In the case of hot air, it is advisable to treat the printed textile at from 180 to 200° C. for about one minute.

A further embodiment of the present invention comprises a crosslinking operation initiated thermally or by actinic radiation, preferably in the UV region.

Useful substrate materials include:
coated or uncoated cellulosics such as paper, paperboard, cardboard, wood and woodbase,
coated or uncoated metallic materials such as foils, sheets or workpieces composed of aluminum, iron, copper, silver, gold, zinc or alloys thereof,
coated or uncoated silicatic materials such as glass, porcelain and ceramics,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,
textile materials such as fibers, yarns, threads, knits, wovens, nonwovens and garments composed of polyester, modified polyester, polyester blend fabrics, cellulosics such as cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric,
leather—both natural and artificial—in the form of smooth leather, nappa leather or suede leather,
comestibles and cosmetics.

The inks according to the invention are notable for advantageous application properties, especially good start-of-print behavior and good sustained use behavior (kogation) and also good drying characteristics. They produce printed images of high quality, i.e., high brilliance and depth of shade and also high rubfastness, lightfastness, waterfastness and wetrubfastness. They are particularly useful for printing coated and uncoated paper and also textile. It is particularly advantageous that the subject process for printing textiles can be performed particularly rapidly and at high throughput per unit time. It was also found that fixation of the print is excellent even after several washes. Similarly, fixation is excellent even in the case of substrates which are singly or repeatedly bent, folded or creased.

The present invention further provides substrates, especially textile substrates, which have been printed by one of the abovementioned processes according to the invention and are notable for particularly crisply printed images or drawings possessing excellent fixation.

The examples which follow illustrate the invention. Unless otherwise stated, the solvents used were dried according to standard methods, see for example Autorenkollektiv Organikum, 3rd reprint of 15th edition, VEB Verlag der Wissenschaften, Leipzig 1984, chapter F: Reagents Appendix (pages 782-809). Nitrogen was dried by passing it through a drying tower packed with Cacl₂ and a drying tower packed with blue gel.

### 1. SYNTHESIS EXAMPLES

1.1. Preparation of a Hyperbranched Polyisocyanate Having an Average NCO Functionality of 7

A reaction vessel fitted with stirrer, dropping funnel, internal thermometer and gas inlet tube was charged with 1 000 g of isophorone diisocyanate while dry nitrogen gas was passed in, followed by 300 g of trimethylolpropane (dissolved in 1 300 g of dry butyl acetate) added over 1 min with thorough stirring. After the metered addition of 0.2 g of dibutyltin dilaurate, the reaction mixture was heated to 50° C. and stirred at this temperature while the decrease in the NCO content was monitored titrimetrically in accordance with DIN 53 185. On attainment of an NCO content of 7.3% by weight, the reaction product had an average NCO functionality of 2 and an average OH functionality of 1. To the addition product were then added 650 g of BASONAT® HI 100 (dissolved in 650 g of dry butyl acetate), and the mixture was heated to 70° C. and stirred at that temperature for 3 h. The end product had an NCO content of 5.9% by weight and a viscosity of 920 mPa·s, measured at 25° C. The average molar mass of the polyisocyanate was 2 609 g/mol, and the average NCO functionality was about 7.

1.2. Reaction of the Hyperbranched Polyisocyanate from 1.1. with Pluriol® A 2000 E and Further Components

A 500 ml four neck flask fitted with stirrer, thermometer and reflux condenser was charged with 100 ml of tetrahydrofuran, 57.1 g (10.6 mmol) of highly branched polyisocyanate from 1.1. and 99.5 g (53.3 mmol) of Pluriol® A 2000 E. The isocyanate content of this mixture was 1.20%. Feed 1 (see below) was then added with stirring. After addition of 2 drops (=50 mg) of dibutyltin dilaurate, the batch was heated to 80° C. and maintained at that temperature until the isocyanate groups had all reacted. 200 ml of distilled water were then added and the tetrahydrofuran (THF) was distilled off under reduced pressure (150 mbar).

Feed 1 was:

131.76 g (22.4 mmol) of polyvinylpyrrolidone, commercially obtainable as Luviskol® K 17 from BASF Aktiengesellschaft, dissolved in 50 ml of THF
   1.3.Example 1.2 was Repeated. Feed 1 was:
6.04 g (22.4 mmol) of stearylamine, dissolved in 50 ml of THF
   1.4. Synthesis of Hyperbranched Polyurethane 1.4:

A reaction vessel fitted with stirrer, internal thermometer, dropping funnel and gas inlet tube was charged with 1 000 g of isophorone diisocyanate (IPDI) at 23° C. under a nitrogen blanket, followed by 300 g of trimethylolpropane (TMP) (dissolved in 1 300 g of anhydrous 2-butanone) added over 1 min with thorough stirring. After metered addition of 0.2 g of dibutyltin dilaurate, the reaction mixture was heated to 50° C. and stirred at that temperature while the decrease in the NCO content was monitored titrimetrically in accordance with DIN 53 185. On attainment of an NCO content of 5.4% by weight, 147 g of 2,4-tolylene diisocyanate (TDI) were added, and the mixture was heated to 60° C. and stirred at that temperature for 1 h. After the reaction had ended, the solution had an NCO content of 5.7% by weight. The calculated average molar mass of the polyisocyanate was 2 420 g/mol, and the average functionality was 5.9 NCO groups per molecule. The 2-butanone was subsequently distilled off at 50 mbar and 50-70° C.

1.5. Synthesis of Hyperbranched Polyurethane Ammonium Salt 1.5:

150 g of the polyisocyanate from example 1.4 were admixed at 23° C. with 150 g of anhydrous acetone in a reaction vessel fitted with stirrer and dropping funnel. A solution of 18.8 g of β-alanine, 100 g of distilled water, 8.4 g of solid sodium hydroxide and 50 g of acetone was subsequently added over 30 s with vigorous stirring and the reaction mixture was stirred at room temperature for 30 min. The product was then freed of acetone and 2-butanone in a rotary evaporator under reduced pressure, dissolved in 1 500 ml of water and precipitated by addition of an excess of 0.1N aqueous hydrochloric acid. After suction filtration and a single wash with 200 ml of water, the product was dried at 50° C. under reduced pressure. The dry acid-functional polyurethane was subsequently admixed with 29 g of 25% aqueous ammonia solution and diluted with water to a 50% aqueous solution of the polyurethane ammonium salt 1.5.

1.6. Synthesis of Hyperbranched Polyurethane Ammonium Salt 1.6:

In a reaction vessel fitted with stirrer, dropping funnel, internal thermometer and gas inlet tube, 150 g of the polyisocyanate from example 1.4 were admixed at 23° C. with 8 g of hydroxyethyl acrylate and 0.05 g of dibutyltin dilaurate, heated to 60° C. and stirred at that temperature for 3 h, all under a nitrogen blanket. The mixture was then cooled to 23° C. and admixed with 150 g of anhydrous acetone. A solution of 12.3 g of β-alanine, 100 g of distilled water, 5.5 g of solid sodium hydroxide and 50 g of acetone was subsequently added over 30 s with vigorous stirring and the reaction mixture was stirred at room temperature for 30 min. The product was then freed of acetone and 2-butanone in a rotary evaporator under reduced pressure, dissolved in 1 500 ml of water and precipitated by addition of an excess of 0.1N aqueous hydrochloric acid. After suction filtration and a single wash with 200 ml of water, the product was dried at 50° C. under reduced pressure. The dry polyurethane which contains acid groups and acrylic double bonds was subsequently admixed with 18 g of 25% aqueous ammonia solution and diluted with water to a 20% by weight aqueous solution of polyurethane ammonium salt 1.6.

1.7. Synthesis of Hyperbranched Polyurethane Ammonium Salt 1.7:

In a reaction vessel fitted with stirrer, dropping funnel, internal thermometer and gas inlet tube, 150 g of the polyisocyanate from example 1.4 were introduced at 23° C. under a nitrogen blanket and admixed with 150 ml of anhydrous acetone. Then at room temperature a solution of 8.9 g of butylamine and 10 g of acetone was added slowly so as not to cause 30° C. to be exceeded. A solution of 12.3 g of β-alanine, 100 g of distilled water, 5.5 g of solid sodium hydroxide and 50 g of acetone was subsequently added over 30 s with vigorous stirring and the reaction mixture was stirred at room temperature for 30 min. The product was then freed of acetone and 2-butanone in a rotary evaporator under reduced pressure, dissolved in 1 500 ml of water and precipitated by addition of an excess of 0.1N aqueous hydrochloric acid. After suction filtration and a single wash with 200 ml of water, the product was dried at 50° C. under reduced pressure. The dry polyurethane which contains acid groups was subsequently admixed with 19 g of 25% aqueous ammonia solution and diluted with water to a 20% by weight aqueous solution of polyurethane ammonium salt 1.7.

1.8. Synthesis of Hyperbranched Ppolyurethane Ammonium Salt 1.8:

A reaction vessel fitted with stirrer, internal thermometer, dropping funnel and gas inlet tube was charged with 672 g of hexamethylene diisocyanate (HDI) and 672 g of anhydrous dimethylacetamide (DMAc) at 23° C. under a nitrogen blanket. A solution of 268 g of trimethylolpropane, 268 g of dimethylolpropionic acid and 1 072 g of anhydrous DMAc was then added over 10 min with thorough stirring. The reaction mixture was then heated to 70° C. and stirred at that temperature while the decrease in the NCO content was monitored titrimetrically in accordance with DIN 53 185. On attainment of an NCO content of 2.0% by weight for the mixture, 400 g of Pluriol® E 400 (difunctional polyethylene glycol, average molar mass 400 g/mol, BASF Aktiengesellschaft) were added and the mixture was subsequently stirred at 60° C. for 3 h. During this time, the NCO content of the mixture dropped to 0%. The product was subsequently freed of solvent in a thin film evaporator at a jacket temperature of 140° C. and a pressure of 1.4 mbar.

The colorless viscid product was adjusted to a pH of 8 with 25% by weight aqueous ammonia solution and subsequently diluted with water to a 50% by weight solution.

### 2. TESTING OF HYPERBRANCHED POLYURETHANES FOR DISPERSING PROPERTIES

General Procedure

The following components were added together in a 50 ml glass bottle:
2.25 g of hyperbranched polyurethane
1.13 g of 1,2-propylene glycol
0.11 g of Proxel® XL2 (biocide)
0.02 g of Etingal® A (defoamer)
15.83 g of water

The bottles were sealed and shaken by hand until all the ingredients were homogeneously dispersed or dissolved. 22.5 g of glass balls 250-420 μm in diameter and 2.25 g of color pigment (Hostaperm® Rosa E-WD) were subsequently added. The bottles were again firmly sealed and the mixtures dispersed in a model BAS 20 Skandex mixer for 2 hours. The particle size of the dispersion was then determined in a DTS 5100 Malvern Zetasizer via light scattering.

Results:

| Hyperbranched | | |
|---|---|---|
| polyurethane | Particle size [nm] | Polydispersity |
| 1.2. | 295 | 0.53 |
| 1.3. | 276 | 0.11 |
| 1.5. | 213 | 0.12 |
| 1.6. | 226 | 0.20 |
| 1.7. | 269 | 0.07 |
| 1.8. | 236 | 0.17 |
| comp 1 | 542 | 0.22 |
| comp 2 | 1 151 | 0.67 |
| comp 3 | 593 | 0.58 |

What is desired is a very low polydispersity coupled with a very small particle size.

### COMPARATIVE EXAMPLES

Comp 1 Polyurethane prepared according to example C in WO 91/14515, page 35, random, no hyperbranched structures

Comp 2 Polyurethane prepared to example 1.1 of U.S. Pat. No. 5,368,944.

Comp 3 Polyurethane prepared to example 2 of U.S. Pat. No. 5,368,944

### 3. PREPARATION AND TESTING OF IN SITU PREPARED DISPERSING BINDERS FROM HYPERBRANCHED POLYURETHANES AND MELAMINE RESIN

The following components were added together in a 50 ml glass bottle:
2.25 g of hyperbranched polyurethane (100%)
1.13 g of 1,2-propylene glycol
0.11 g of Proxel® XL2 (biocide)
0.02 g of Etingal® A
15.75 g of water
0.99 g of Cymel® 327 (melamine derivative)

The bottles were sealed and shaken by hand until all the ingredients were homogeneously dispersed or dissolved. 22.5 g of glass balls 250-420 μm in diameter and 2.25 g of color pigment (P.R.122) were subsequently added. The bottles were again firmly sealed and the mixtures dispersed in a model BAS 20 Skandex mixer for 2×2 hours. The particle size of the dispersion was then determined in a DTS 5100 Malvern Zetasizer via light scattering.

Results:

| Dispersing | Hyperbranched | Particle | |
|---|---|---|---|
| binder | polyurethane | size [nm] | Polydispersity |
| 2.1 | 1.5 | 192 | 0.17 |
| (comp 2.2) | 1.5 | 170 | 0.28 |
| 2.3 | 1.6 | 212 | 0.10 |
| (comp 2.4) | 1.6 | 185 | 0.19 |
| 2.5 | 1.7 | 225 | 0.21 |
| (comp 2.6) | 1.7 | 222 | 0.04 |

The comparative examples 2.2, 2.4 and 2.6 are not dispersing binders within the meaning of the present invention, but are hyperbranched polyurethanes.

Column 2 lists the hyperbranched polyurethanes in question, which were either used as dispersants per se (comp 2.2, comp 2.4 and comp 2.6) or formed the basis for the in situ preparation of the dispersing binders of the present invention.

1. A recording fluid comprising water, one or more finely divided organic or inorganic colorants and at least one polyurethane having hyperbranched structures selected from the group consisting of at least one hyperbranched polyurethane and at least one modified hyperbranched polyurethane.

2. The recording fluid as claimed in claim 1, wherein the recording fluid is an ink.

3. The recording fluid as claimed in claim 1, wherein the recording fluid is an ink for the ink jet process.

4. The recording fluid as claimed in claim 1, wherein the recording fluid comprises the at least one modified hyperbranched polyurethane and said at least one modified hyperbranched polyurethane is obtained by reacting the at least one hyperbranched polyurethane with one or more polymers of the general formula I
U-(M)y-T I
wherein
U is selected from the group consisting of hydrogen, C₁-C₁₈-alkyl, C₇-C₁₃-aralkyl, C₆-C₁₄-aryl and a residue from a free-radical initiator molecule,
M represents the same or different monomer units;
y is an integer from 10 to 100 000; and
T represents functional groups which react with the NCO groups or OH groups of the at least one hyperbranched polyurethane
to form the at least one modified hyperbranched polyurethane.

5. The recording fluid as claimed in claim 1, wherein the modified hyperbranched polyurethane is obtained by reacting one or more hyperbranched polyurethanes with one or more polyether derivatives selected from the group consisting of
polyalkylene glycol derivatives of the general formula II, 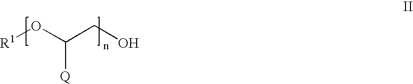
polytetrahydrofuran derivatives of the general formula III, 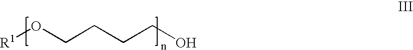
branched or unbranched copolymers of ethylene oxide and propylene oxide or butylene oxide,
branched or unbranched terpolymers of ethylene oxide and propylene oxide and butylene oxide,
and mixtures thereof
wherein
R¹ is selected from the group consisting of
hydrogen,
C₁-C₄₀-alkyl which may be substituted by one or more hydroxyl groups with the proviso that the number of hydroxyl groups is not more than the number of carbon atoms in the C₁-C₄₀-alkyl,
C₇-C₁₃-aralkyl and
C₆-C₁₄-aryl,
Q is independently selected from the group consisting of hydrogen and methyl, and
n is an integer from 2 to 500.

6. The recording fluid as claimed in claim 1, wherein the at least one modified hyperbranched polyurethane is obtained by reacting a deficiency, based on the NCO groups of the at least one hyperbranched polyurethane, of polymer represented by formula I
U-(M)y-T I
and subsequently converting the unconverted NCO groups into groups having affinity for pigment,
wherein
U is selected from the group consisting of hydrogen, C₁-C₁₈-alkyl, C₇-C₁₃-aralkyl, C₆-C₁₄-aryl and a residue from a free-radical initiator molecule,
M represents the same or different monomer units;
y is an integer from 10 to 100 000; and
T represents functional groups which react with the NCO groups or OH groups of the at least one hyperbranched polyurethane
to form said at least one modified hyperbranched polyurethane.

7. The recording fluid as claimed in claim 1, wherein the NCO groups are reacted with aliphatic or aromatic alcohols, thiols, amines, carboxylic acid derivatives, sulfonic acid derivatives or urea derivatives to form groups having affinity for pigment.

8. The recording fluid as claimed in claim 1, further comprising one or more melamine derivatives of the general formula IV 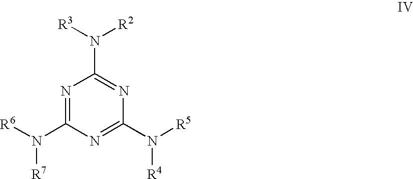
wherein
R² to R⁷ are independently selected from the group consisting of hydrogen, CH₂—OR⁸, CH(OR⁸)₂ and CH2-N(R⁸)₂,
wherein R⁸ is independently selected from the group consisting of
hydrogen,
C₁-C₁₂-alkyl, branched or unbranched; and
alkoxyalkylene selected from the group consisting of (—CH₂—CH₂—O)ₘ—H, (—CHCH₃—CH₂—O)ₘ—H, (—CH₂—CHCH₃—O)ₘ—H, and (—CH₂—CH₂—CH₂—CH₂—O)ₘ—H,
wherein
m is an integer from 1 to 20.

9. The recording fluid as claimed in claim 8, wherein R² and R³ are both hydrogen.

10. The recording fluid as claimed in claim 8, wherein R⁴ is CH₂OH.

11. A process for preparing the recording fluid as claimed in claim 1, the process comprising:
intimately mixing said at least one hyperbranched polyurethane or at least one modified hyperbranched polyurethane with
water,
one or more finely divided inorganic or organic colorants,
optionally a melamine derivative of the general formula IV and
optionally assistants,
wherein the melamine derivative of formula IV is represented by 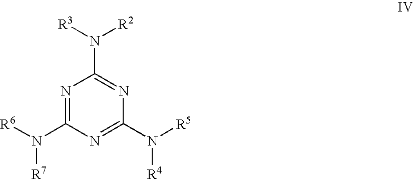
R² to R⁷ are independently selected from the group consisting of hydrogen, CH₂—OR⁸, CH(OR⁸)₂ and CH2-N(R⁸)₂,
wherein R⁸ is independently selected from the group consisting of
hydrogen,
C₁-C₁₂-alkyl, branched or unbranched; and
alkoxyalkylene selected from the group consisting of (—CH₂—CH₂—O)ₘ—H, (—CHCH₃—CH₂—O)ₘ—H, (—CH₂—CHCH₃—O)ₘ—H, and (—CH₂—CH₂—CH₂—CH₂—O)ₘ—H,
wherein
m is an integer from 1 to 20.

12. A process for printing sheetlike or three-dimensional substrates by an ink jet process, the process comprising:
ink-jet printing the sheetlike or three-dimensional substrates with the recording fluid as claimed in claim 1.

13. A sheetlike substrate and/or three-dimensional substrate obtained by the process as claimed in claim 12.
